(19) United States
(12) Patent Application Publication
(10) Pub. No.: US 2023/0143457 A1
(43) Pub. Date: May 11, 2023

(54) REPORTING A SELECTED DEMODULATION REFERENCE SIGNAL CONFIGURATION AND CORELATED CHANNEL STATE FEEDBACK

(71) Applicant: QUALCOMM Incorporated, San Diego, CA (US)

(72) Inventors: Michael LEVITSKY, Rehovot (IL); Alexandros MANOLAKOS, Escondido, CA (US); Peter GAAL, San Diego, CA (US); Chenxi HAO, Beijing (CN); Jacob PICK, Beit Zayit (IL); Assaf TOUBOUL, Netanya (IL)

(21) Appl. No.: 17/907,654

(22) PCT Filed: Jun. 5, 2020
(86) PCT No.: PCT/CN2020/094526

§ 371 Date: Sep. 28, 2022

(51) Int. Cl. H04L 5/00; H04W 24/10

(52) U.S. Cl. CPC H04L 5/0051; H04W 24/10

(57) ABSTRACT

Various aspects of the present disclosure generally relate to wireless communication. In some aspects, a user equipment may select, from a set of demodulation reference signal (DMRS) configurations, a recommended DMRS configuration for a downlink communication, the recommended DMRS configuration associated with a set of DMRS parameters; and transmit an indication of the recommended DMRS configuration. Numerous other aspects are provided.

### FIELD OF THE DISCLOSURE

Aspects of the present disclosure generally relate to wireless communication and to techniques and apparatuses for reporting a selected demodulation reference signal configuration and corelated channel state feedback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes selecting, from a set of demodulation reference signal (DMRS) configurations, a recommended DMRS configuration for a physical downlink shared channel (PDSCH), the recommended DMRS configuration associated with a set of DMRS parameters; and transmitting an indication of the recommended DMRS configuration.

In some aspects, a method of wireless communication performed by a base station includes receiving a channel state feedback (CSF) report and an indication of a recommended DMRS configuration associated with one or more parameters used by a UE to generate the CSF report; and selecting, based at least in part on the CSF report and the recommended DMRS configuration, transmission parameters, including a DMRS configuration, to use for a PDSCH.

In some aspects, a non-transitory computer-readable medium storing a set of instructions for wireless communication includes one or more instructions that, when executed by one or more processors of a UE, cause the UE to select, from a set of DMRS configurations, a recommended DMRS configuration for a PDSCH, the recommended DMRS configuration associated with a set of DMRS parameters; and transmit an indication of the recommended DMRS configuration.

In some aspects, a non-transitory computer-readable medium storing a set of instructions for wireless communication includes one or more instructions that, when executed by one or more processors of a base station, cause the base station to receive a CSF report and an indication of a recommended DMRS configuration associated with one or more parameters used by a UE to generate the CSF report; and select, based at least in part on the CSF report and the recommended DMRS configuration, transmission parameters, including a DMRS configuration, to use for a PDSCH.

In some aspects, a UE for wireless communication includes a memory; and one or more processors operatively coupled to the memory, the memory and the one or more processors configured to select, from a set of DMRS configurations, a recommended DMRS configuration for a PDSCH, the recommended DMRS configuration associated with a set of DMRS parameters; and transmit an indication of the recommended DMRS configuration.

In some aspects, a base station for wireless communication includes a memory; and one or more processors operatively coupled to the memory, the memory and the one or more processors configured to receive a CSF report and an indication of a recommended DMRS configuration associated with one or more parameters used by a UE to generate the CSF report; and select, based at least in part on the CSF report and the recommended DMRS configuration, transmission parameters, including a DMRS configuration, to use for a PDSCH.

In some aspects, an apparatus for wireless communication includes means for selecting, from a set of DMRS configurations, a recommended DMRS configuration for a PDSCH, the recommended DMRS configuration associated with a set of DMRS parameters; and means for transmitting an indication of the recommended DMRS configuration.

In some aspects, an apparatus for wireless communication includes means for receiving a CSF report and an indication of a recommended DMRS configuration associated with one or more parameters used by a UE to generate the CSF report; and means for selecting, based at least in part on the CSF report and the recommended DMRS configuration, transmission parameters, including a DMRS configuration, to use for a PDSCH.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of channel state feedback reporting, in accordance with various aspects of the present disclosure.

FIG. 4 is a diagram illustrating an example associated with reporting channel state feedback and one or more correlated demodulation reference signal configurations, in accordance with various aspects of the present disclosure.

FIGS. 5-7 are diagrams illustrating examples associated with demodulation reference signal patterns for different physical downlink shared channel allocation durations, in accordance with various aspects of the present disclosure.

FIGS. 8 and 9 are diagrams illustrating examples associated with types of demodulation reference signals, in accordance with various aspects of the present disclosure.

FIGS. 10 and 11 are diagrams illustrating example processes associated with reporting channel state feedback and correlated demodulation reference signal configurations, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

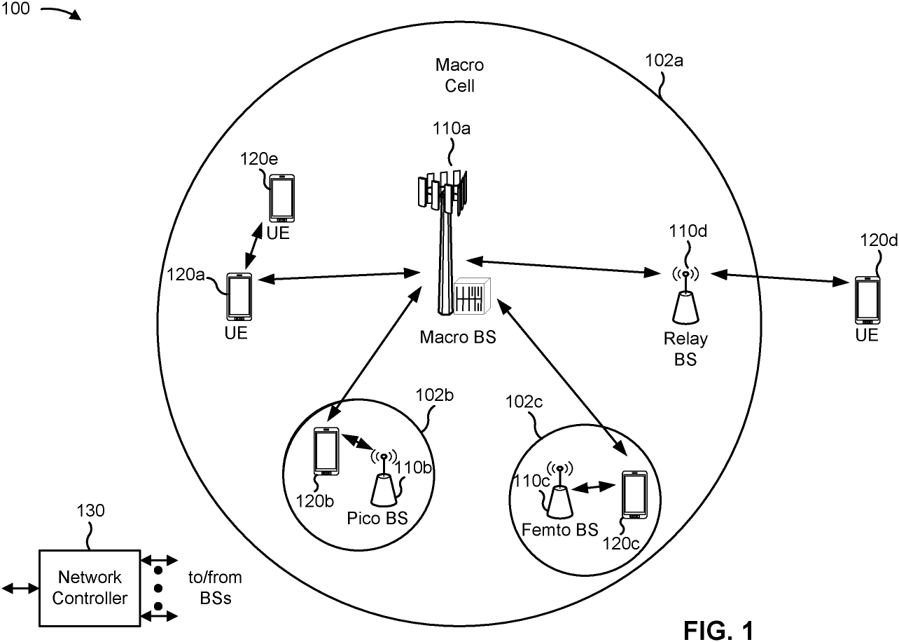

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

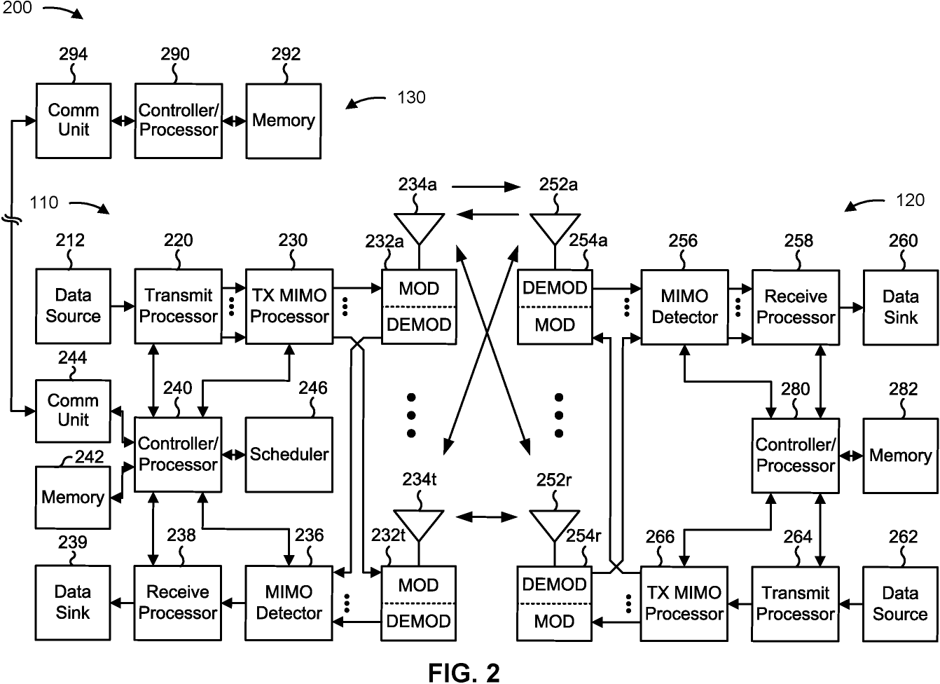

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a DMRS, and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

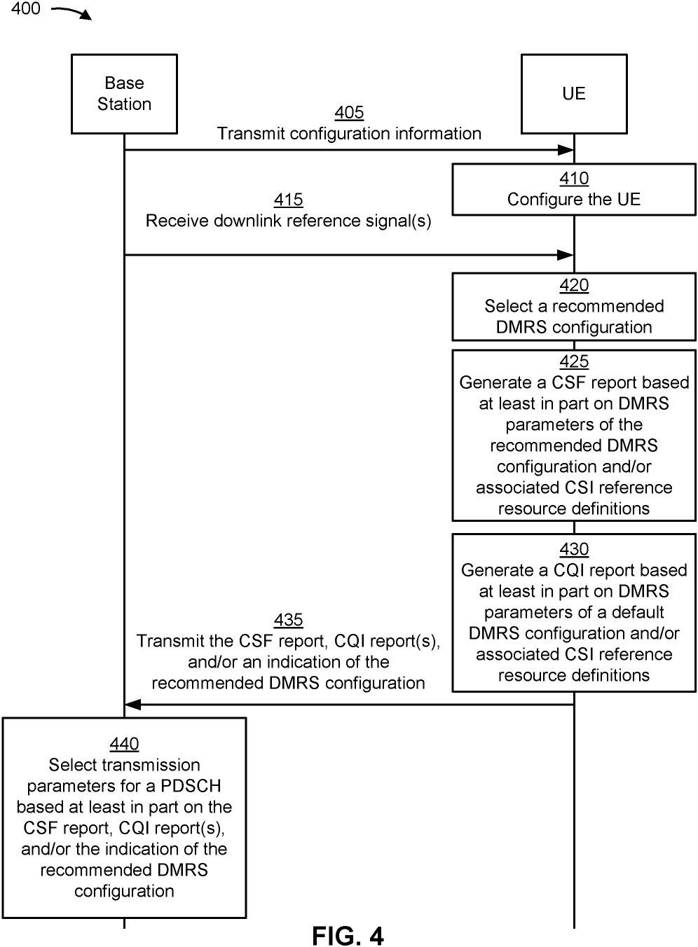

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-11.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-11.

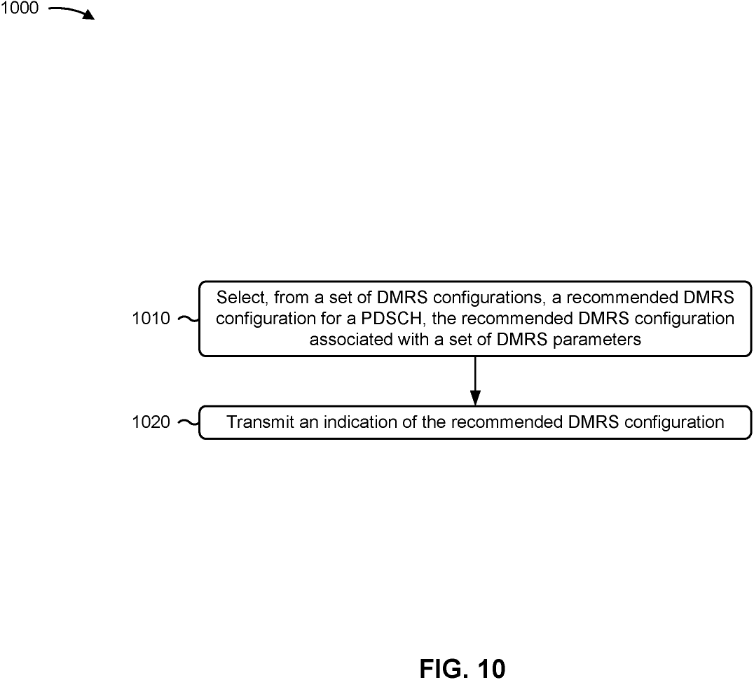

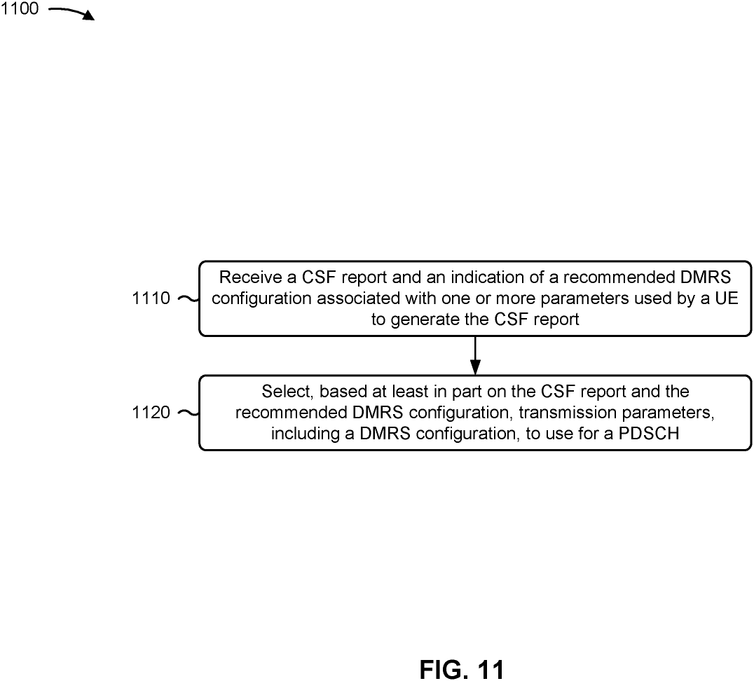

Controller/processor 240 of base station 110, controller/processor 280 of UE 120, and/or any other component(s) of FIG. 2 may perform one or more techniques associated with reporting CSF and correlated DMRS configurations, as described in more detail elsewhere herein. For example, controller/processor 240 of base station 110, controller/processor 280 of UE 120, and/or any other component(s) of FIG. 2 may perform or direct operations of, for example, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some aspects, executing instructions may include running the instructions, converting the instructions, compiling the instructions, interpreting the instructions, and/or the like.

In some aspects, UE 120 may include means for selecting, from a set of DMRS configurations, a recommended DMRS configuration for a PDSCH, the recommended DMRS configuration associated with a set of DMRS parameters; means for transmitting an indication of the recommended DMRS configuration; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for receiving a CSF report and an indication of a recommended DMRS configuration associated with one or more parameters used by a UE to generate the CSF report; means for selecting, based at least in part on the CSF report and the recommended DMRS configuration, transmission parameters, including a DMRS configuration, to use for a PDSCH; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of processor 280.

As indicated above, FIG. 2 is provided as an example. Other examples may differ from what is described with regard to FIG. 2.

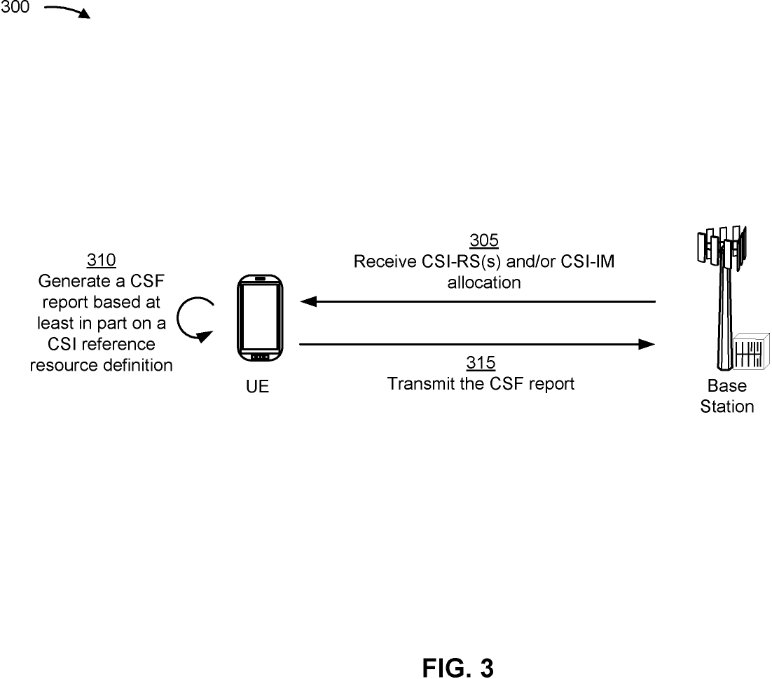

FIG. 3 is a diagram illustrating an example 300 of CSF reporting, in accordance with various aspects of the present disclosure. As shown, a UE and a base station may communicate within a wireless network. The UE and the base station may have already established a wireless link and may periodically perform a CSF reporting process, as shown.

As shown in FIG. 3, and by reference number 305, the UE may receive one or more channel state information (CSI) reference signals (CSI-RSs), CSI interference measurement (CSI-IM) allocations, and/or the like. The UE may evaluate the one or more CSI-RSs to determine channel quality indicators (CQIs), recommended rank indicators (RIs), pre-coding matrix indicators (PMIs), and/or the like for respective CSI-RSs of the one or more CSI-RSs. The UE may determine the CQIs based at least in part on CSI reference resource definitions.

The CSI reference resource definitions may provide a set of definitions and/or assumptions for the UE to use to evaluate the CSI-RSs. For example, the CSI reference resource definitions may indicate that two first symbols (e.g., OFDM symbols) of a physical downlink shared channel (PDSCH) are occupied by control signaling, that a number of PDSCH and DMRS symbols is equal to 12, to assume that a number of front loaded DMRS symbols is a same number as a maximum number of front loaded symbols as configured by a higher layer (e.g., radio resource control (RRC)) parameter (e.g., maxLength) in a DMRS configuration indication (e.g., DMRS-DownlinkConfig), to assume that a number of additional DMRS symbols is a same number as a number of additional symbols configured by a higher layer parameter (e.g., DMRS-AdditionalPosition), to assume that PDSCH symbols do not contain DMRSs, and/or the like.

As shown by reference number 310, the UE may generate a CSF report based at least in part on the CSI resource definition. For example, the UE may evaluate the one or more CSI-RSs to determine the CQIs, recommended RIs, PMIs, and or the like to determine which RI and PMI are associated with the UE receiving a communication via the PDSCH with a highest spectral efficiency and/or a CQI corresponding to a 10% block error ratio (BLER) for PDSCH communications based at least in part on the CSI reference resource definitions. The UE may generate the report to indicate one or more CQIs (e.g., for the selected RI and PMI that correspond to the highest spectral efficiency).

As shown by reference number 315, the UE may transmit the CSF report to the base station. The base station may determine one or more transmission parameters based at least in part on the CSF report.

In this way, the base station may determine transmission parameters to use for PDSCH allocations based at least in part on definitions of a CSI reference resource that refer to one or more parameter of a higher layer configured DMRSs configuration. However, if the UE is configured to select a recommended DMRS configuration, an evaluation of CSI-RSs using assumptions relying on one or more parameters of a higher layer configured DMRS configuration may result in a CSF report that is not consistent with the recommended DMRS configuration and which may allow the UE to achieve a higher spectral efficiency for associated channel and reception conditions. This may cause the base station to use transmission parameters that do not allow the UE to exploit a potential spectral efficiency gain that may be achieved with the recommended DMRS configuration.

As indicated above, FIG. 3 is provided as an example. Other examples may differ from what is described with respect to FIG. 3.

In some aspects described herein, a UE may be configured to receive one or more downlink reference signals and determine a recommended DMRS configuration (e.g., a DMRS configuration to recommend for a base station to use for transmitting PDSCH communications and/or PDSCH allocations) based on the one or more reference signals. The UE may evaluate the one or more downlink reference signals based at least in part on CSI reference resource definitions that are associated with (e.g., that assume) parameters of the recommended DMRS configuration. For example, the CSI reference resource definitions may refer to parameters of the DMRS configuration such as a number of front loaded DMRS symbols, a number of additional DMRS symbols (e.g., a number of symbol locations), locations of DMRS symbols relative to PDSCH allocation boundaries on time axis, an assumption of a PDSCH allocation duration (e.g., based at least in part on the recommended DMRS configuration, a type of DMRS, a DMRS boosting configuration, and/or the like.

The UE may transmit an indication of the recommended DMRS, assumed at least in part for generation of a CSF report that includes at least one CQI that is based at least in part on the recommended DMRS configuration, as a part of the CSF report, coupled to the CSF report, and/or the like. The base station may use the CSF report and the indication of the recommended DMRS configuration to select transmission parameters to use for a PDSCH (e.g., a communication using the PDSCH). In this way, the UE may transmit the CSF report and an indication of a corresponding recommended DMRS configuration (e.g., assumed for determination of the CSF report) so the base station may select transmission parameters (e.g., including a DMRS configuration) that are likely to achieve a highest spectral efficiency for associated channel and link conditions (e.g., a balance between a number of resources to carry data and a number of pilots to assist the UE to demodulate and/or decode the data). This may conserve network resources that may otherwise be used to transmit an unnecessarily high number of pilots in some cases, or a high number of data resources with a low decoding success rate in other cases (e.g., based at least in part on an insufficient number of pilots), and/or the like.

FIG. 4 is a diagram illustrating an example 400 associated with reporting CSF and one or more correlated DMRS configurations, in accordance with various aspects of the present disclosure. As shown in FIG. 4, a UE (e.g., UE 120) may communicate with a base station (e.g., base station 110). The UE and the base station may be part of a wireless network (e.g., wireless network 100).

As shown by reference number 405, the base station may transmit, and the UE may receive, configuration information. In some aspects, the UE may receive configuration information from another device (e.g., from another base station, another UE, and/or the like). In some aspects, the UE may receive the configuration information via one or more of RRC signaling, medium access control (MAC) signaling (e.g., MAC control elements (MAC CEs)), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may identify a set of DMRS configurations from which the UE may select a recommended DMRS configuration for a PDSCH. In some aspects, configuration information may indicate that the UE is to select the recommended DMRS configuration based at least in part on one or more downlink reference signals (e.g., a CSI reference signal, a CSI interference measurement (CSI-IM), a tracking reference signal (TRS), or a downlink DMRS), and/or the like.

The configuration information may indicate one or more configuration parameters for determining a set of definitions of CSI reference resources. In some aspects, the set of definitions of CSI reference resources may refer to parameters of the recommended DMRS configuration. In some aspects, the configuration information may indicate that the UE is to use the recommended DMRS configuration for one or more of the definitions of the CSI reference resource (e.g., with reference to the parameters of the recommended DMRS configuration) to evaluate the one or more downlink reference resources (e.g., for generating one or more CSF reports), to determine one or more CQIs associated with the one or more selected DMRS configurations/options.

The configuration information may indicate that the UE is to generate a CSF report that indicates at least one CQI, determined based at least in part on a set of DMRS parameters that correspond to the recommended DMRS configuration, that is used as a basis for one or more CSI reference resource definitions. The configuration information may indicate that the UE is to transmit an indication of the recommended DMRS configuration as part of the CSF report, coupled to the CSF report, with an identifier to link the indication to the CSF report, and/or the like.

As shown by reference number 410, the UE may configure the UE for communicating with the base station. In some aspects, the UE may configure the UE based at least in part on the configuration information. In some aspects, the UE may be configured to perform one or more operations described herein.

In some aspects, the UE may transmit, and the base station may receive, an indication of a capability of the UE to determine a recommended DMRS configuration, evaluate downlink reference signals based at least in part on the recommended DMRS configuration, generate a CSF report based at least in part on the recommended DMRS configuration, transmit the CSF report and/or an indication of the recommended DMRS configuration, and/or the like. In some aspects, the UE may transmit the indication of the capability of the UE via RRC signaling, one or more MAC CEs, a physical uplink control channel (PUCCH) message, and/or the like.

As shown by reference number 415, the UE may receive, and the base station may transmit, one or more downlink reference signals that can be used to determine downlink channel characteristics and link conditions. In some aspects, the one or more downlink reference signals may include one or more CSI-RSs, CSI-IMs, TRSs, DMRSs, system information blocks, and/or the like.

As shown by reference number 420, the UE may select a recommended DMRS configuration based at least in part on the one or more downlink reference signals. In some aspects, the UE may select the recommended DMRS configuration from a set of DMRS configurations (e.g., configured via higher layer (e.g., RRC, MAC, and/or the like) signaling). The UE may select the recommended DMRS configuration based at least in part on channel characteristics or reception conditions estimated based at least in part on one or more downlink reference signals. In some aspects, the recommended DMRS configuration may be selected based at least in part on the UE determining that the recommended DMRS configuration is a most appropriate DMRS configuration for channel characteristics and/or reception conditions as estimated based at least in part on the one or more downlink reference signals. For example, the UE may determine that the recommended DMRS configuration maximizes a PDSCH spectral efficiency compared with other DMRS configurations.

As shown in reference number 425, the UE may generate a CSF report based at least in part on DMRS parameters of the recommended DMRS configuration and/or associated CSI reference resource definitions. In some aspects, the CSF report may include at least one CQI report (e.g., an indication of a CQI), an indication of a recommended RI, a PMI, and/or the like determined based at least in part on the recommended DMRS configuration. The CSF report may include, or be coupled to, an indication of the recommended DMRS configuration used to determine a CQI for the at least one CQI report, the recommended RI, the PMI, and/or the like.

In some aspects, a set of definitions for a CSI reference resource, for generating the CSF report, is based at least in part on the set of DMRS parameters. For example, the set of definitions for the CSI reference resources may include definitions and/or assumptions, such as: a number of one or more front loaded DMRS symbols is based at least in part on the recommended DMRS configuration; a number of one or more additional DMRS symbols and/or associated locations is based at least in part on the recommended DMRS configuration; locations of DMRS symbols, relative to a first and last symbol of a PDSCH allocation with the corresponding assumption of the allocation duration, are based at least in part on the recommended DMRS configuration; a type of DMRS for the PDSCH is based at least in part on the recommended DMRS configuration; and/or the like. In some aspects, the set of definitions for the CSI reference resources may include definitions and/or assumptions, such as: an allocation duration for a PDSCH is based at least in part on the recommended DMRS configuration; a PDSCH includes DMRS symbols according to the recommended DMRS configuration; a DMRS boosting configuration and an assumption regarding multiplexing of DMRS resources and data resources on DMRS symbols are based at least in part on the recommended DMRS configuration; and/or the like.

In some aspects, the set of definitions for the CSI reference resource may include a first subset of definitions associated with determinations of a transport block size, a code block segmentation, a code block length associated with determining a CQI, and/or the like. In some aspects, the first subset of definitions may be based at least in part on a set of assumptions including that a sum of a number of PDSCH symbols and DMRS symbols is equal to 12 symbols, that PDSCH symbols do not include DMRSs, and/or the like.

The set of definitions for the CSI reference resource may also include a second subset of definitions, that is independent from the first subset of definitions, associated with determinations of one or more of a recommended RI, a PMI, the recommended DMRS configuration, and/or the like. In some aspects, the recommended DMRS configuration and a corresponding PDSCH allocation duration may define a code block size and/or coding performance. The second subset of definitions may also be associated with a CQI determination that excludes transport block size, the code block segmentation, the code block length, associated parameters, and/or the like. In some aspects, the UE may determine CQI based at least in part on the recommended DMRS configuration affecting an estimated spectral efficiency.

In some aspects, the UE may select the recommended DMRS configuration and generate the CSF report jointly and/or iteratively. In some aspects, the UE may select a PMI and an RI and then select the recommended DMRS configuration. The UE may select a CQI based at least in part on the recommended DMRS configuration, the PMI, the RI, and/or the like.

As shown by reference number 430, the UE may generate a CQI report based at least in part on DMRS parameters of a default DMRS configuration and/or associated CSI reference resource definitions. In some aspects, the default DMRS configuration may be based at least in part on a communication standard (e.g., explicitly, based at least in part on one or more configured parameters, and/or the like), RRC signaling, downlink control information, one or more MAC CEs, the recommended DMRS configuration, and/or the like. In some aspects, the UE may generate a first CQI report associated with the default DMRS configuration with a second CQI report associated with the recommended DMRS configuration. In some aspects, the first CQI report and the second CQI report may be parts of a single CSF report, may be transmitted within a single uplink transmission, may be coupled for transmission, and/or the like.

The default DMRS configuration may be associated with a set of definitions for a CSI reference resource including that a number of one or more front loaded DMRS symbols is based at least in part on the default DMRS configuration; a number of one or more additional DMRS symbols is based at least in part on the default DMRS configuration; locations of DMRS symbols, relative to a first and/or last symbols of a PDSCH allocation (e.g., with a corresponding assumption of a default PDSCH allocation duration), are based at least in part on the default DMRS configuration; a type of DMRS for the PDSCH is based at least in part on the default DMRS configuration; and or the like.

In some aspects, the default DMRS configuration may be associated with a set of definitions for a CSI reference resource including that an allocation duration for a PDSCH is based at least in part on the default DMRS configuration; a PDSCH includes DMRS symbols according to the default DMRS configuration; a DMRS boosting configuration and an assumption regarding multiplexing of DMRS resources and data resources on DMRS symbols are based at least in part on the recommended DMRS configuration; and/or the like.

As shown by reference number 435, the UE may transmit, and the base station may receive, the CSF report, one or more CQI reports, and/or an indication of the recommended DMRS configuration. In some aspects, the CSF report may include a CQI report associated with the recommended DMRS configuration, a CQI report associated with the default DMRS configuration, the indication of the recommended DMRS configuration, and/or the like. In some aspects, the CQI report associated with the recommended DMRS configuration, the CQI report associated with the default DMRS configuration, and/or the indication of the recommended DMRS configuration may be coupled to the CSF report, transmitted separately from the CSF report, and/or the like.

In some aspects, the UE may report the indication of the recommended DMRS configuration based at least in part on a CSI framework. For example, the UE may report the indication of the recommended DMRS configuration based at least in part on a configuration under a CSI report configuration, the UE may use intermediate results of a CSF evaluation of reference signals to select the recommended DMRS configuration, the UE may report the indication of the recommended DRMS configuration as part of an extended CSF report or as coupled reports. In some aspects, the UE may transmit the CSF report with indications of multiple CQI and DMRS configuration pairs.

As shown by reference number 440, the base station may select one or more transmission parameters for a PDSCH based at least in part on the CSF report, the one or more CQI reports, and/or the indication of the recommended DMRS configuration. In some aspects, the base station may determine whether to adopt the recommended DMRS configuration, a recommended RI, a PMI, and/or the like (e.g., based at least in part on scheduling restraints, channel characteristics, Doppler conditions, and/or the like). In some aspects, the base station may determine to adjust one or more transmission parameters associated with the CSF report or the recommended DMRS configuration based at least in part on the set of CSI reference resource definitions. The base station may then transmit a PDSCH communication to the UE based at least in part on the one or more adjusted transmission parameters.

Based at least in part on the UE using the recommended DMRS configuration to generate the CSF report and transmitting the indication of the recommended DMRS configuration, the base station may select transmission parameters that are likely to achieve a highest spectral efficiency (e.g., a balance between a number of resources to carry data and a number of pilots to assist the UE to demodulate and/or decode the data). This may conserve network resources that may otherwise be used to transmit an unnecessarily high number of pilots, a high number of data resources with a low decoding success rate (e.g., based at least in part on an insufficient number of pilots), and/or the like.

As indicated above, FIG. 4 is provided as an example. Other examples may differ from what is described with respect to FIG. 4.

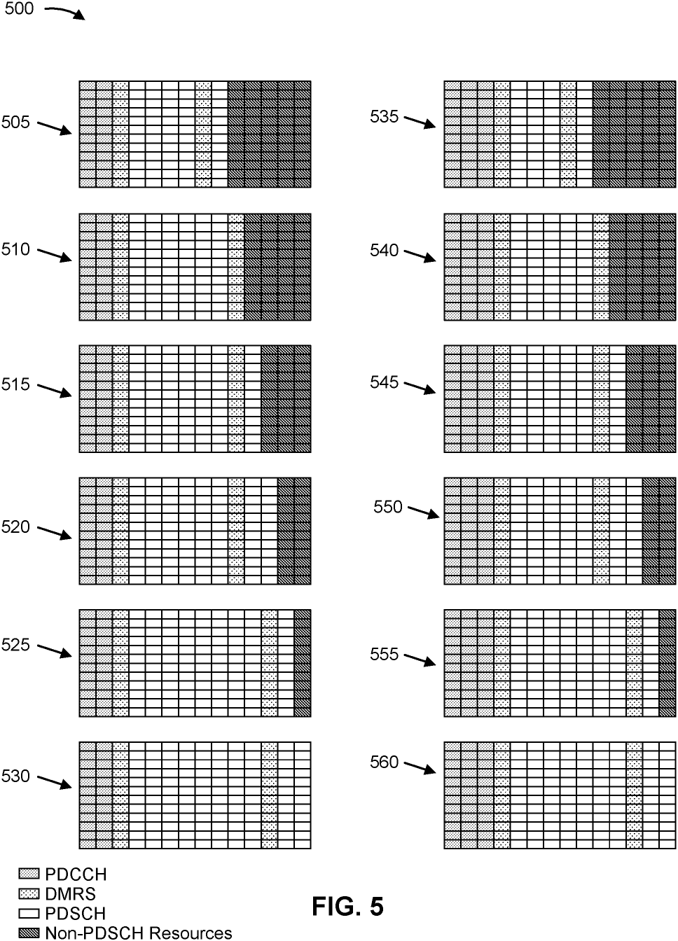

FIGS. 5-7 are diagrams illustrating examples 500, 600, and 700 associated with DMRS patterns for different PDSCH allocation durations, in accordance with various aspects of the present disclosure.

As shown in FIG. 5, and by reference number 505, a DMRS configuration may include two first symbols allocated to a physical downlink control channel (PDCCH), two symbols allocated for DMRSs spaced within five symbols allocated for the data of the PDSCH, and five final symbols allocated for non-PDSCH resources (e.g., physical uplink shared channel (PUSCH) resources).

As shown by reference number 510, a DMRS configuration may include two first symbols allocated to a PDCCH, two symbols allocated for DMRSs spaced at either end of six symbols allocated for the data of the PDSCH, and four final symbols allocated for non-PDSCH resources.

As shown by reference number 515, a DMRS configuration may include two first symbols allocated to a PDCCH, two symbols allocated for DMRSs spaced within seven symbols allocated for the data of the PDSCH, and three final symbols allocated for non-PDSCH resources.

As shown by reference number 520, a DMRS configuration may include two first symbols allocated to a PDCCH, two symbols allocated for DMRSs spaced within eight symbols allocated for the data of the PDSCH, and two final symbols allocated for non-PDSCH resources.

As shown by reference number 525, a DMRS configuration may include two first symbols allocated to a PDCCH, two symbols allocated for DMRSs spaced within nine symbols allocated for the data of the PDSCH, and one final symbol allocated for non-PDSCH resources.

As shown by reference number 530, a DMRS configuration may include two first symbols allocated to a PDCCH, and two symbols allocated for DMRSs spaced within ten symbols allocated for the data of the PDSCH.

As shown by reference number 535, a DMRS configuration may include three first symbols allocated to a PDCCH, two symbols allocated for DMRSs spaced within four symbols allocated for the data of the PDSCH, and five final symbols allocated for non-PDSCH resources.

As shown by reference number 540, a DMRS configuration may include three first symbols allocated to a PDCCH, two symbols allocated for DMRSs spaced at either side of five symbols allocated for the data of the PDSCH, and four final symbols allocated for non-PDSCH resources.

As shown by reference number 545, a DMRS configuration may include three first symbols allocated to a PDCCH, two symbols allocated for DMRSs spaced within six symbols allocated for the data of the PDSCH, and three final symbols allocated for non-PDSCH resources.

As shown by reference number 550, a DMRS configuration may include three first symbols allocated to a PDCCH, two symbols allocated for DMRSs spaced within seven symbols allocated for the data of the PDSCH, and two final symbols allocated for non-PDSCH resources.

As shown by reference number 555, a DMRS configuration may include three first symbols allocated to a PDCCH, two symbols allocated for DMRSs spaced within eight symbols allocated for the data of the PDSCH, and one final symbol allocated for non-PDSCH resources.

As shown by reference number 560, a DMRS configuration may include three first symbols allocated to a PDCCH, and two symbols allocated for DMRSs spaced within nine symbols allocated for the data of the PDSCH.

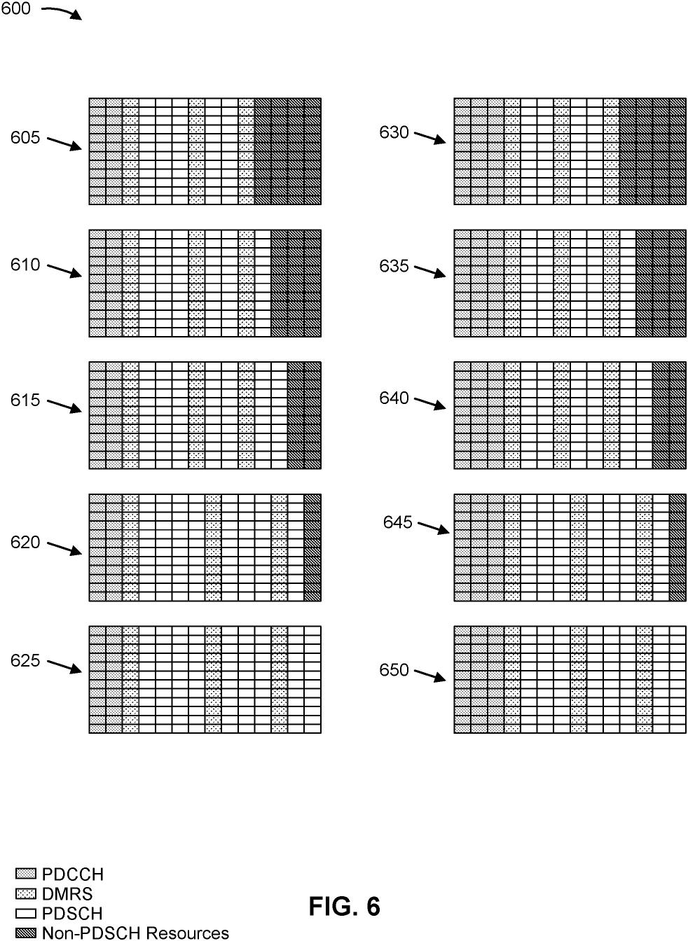

As shown in FIG. 6, and by reference number 605, a DMRS configuration may include two first symbols allocated to a PDCCH, three symbols allocated for DMRSs spaced within five symbols allocated for the data of the PDSCH, and four final symbols allocated for non-PDSCH resources.

As shown by reference number 610, a DMRS configuration may include two first symbols allocated to a PDCCH, three symbols allocated for DMRSs spaced within six symbols allocated for the data of the PDSCH, and three final symbols allocated for non-PDSCH resources.

As shown by reference number 615, a DMRS configuration may include two first symbols allocated to a PDCCH, three symbols allocated for DMRSs spaced within seven symbols allocated for the data of the PDSCH, and two final symbols allocated for non-PDSCH resources.

As shown by reference number 620, a DMRS configuration may include two first symbols allocated to a PDCCH, three symbols allocated for DMRSs spaced within eight symbols allocated for the data of the PDSCH, and one final symbol allocated for non-PDSCH resources.

As shown by reference number 625, a DMRS configuration may include two first symbols allocated to a PDCCH, and three symbols allocated for DMRSs spaced within nine symbols allocated for the data of the PDSCH.

As shown by reference number 630, a DMRS configuration may include three first symbols allocated to a PDCCH, three symbols allocated for DMRSs spaced within four symbols allocated for the data of the PDSCH, and four final symbols allocated for non-PDSCH resources.

As shown by reference number 635, a DMRS configuration may include three first symbols allocated to a PDCCH, three symbols allocated for DMRSs spaced within five symbols allocated for the data of the PDSCH, and three final symbols allocated for non-PDSCH resources.

As shown by reference number 640, a DMRS configuration may include three first symbols allocated to a PDCCH, three symbols allocated for DMRSs spaced within six symbols allocated for the data of the PDSCH, and two final symbols allocated for non-PDSCH resources.

As shown by reference number 645, a DMRS configuration may include three first symbols allocated to a PDCCH, three symbols allocated for DMRSs spaced within seven symbols allocated for the data of the PDSCH, and one final symbol allocated for non-PDSCH resources.

As shown by reference number 650, a DMRS configuration may include three first symbols allocated to a PDCCH, and three symbols allocated for DMRSs spaced within eight symbols allocated for the data of the PDSCH.

In some aspects, DMRS symbol locations may be associated with (e.g., coupled to) corresponding PDSCH allocation durations, PDSCH mapping type, and/or the like. In some aspects, different options of DMRS symbol locations with different PDSCH allocation durations may introduce different channel estimation error floors for different channel scenarios. Based at least in part on having different channel estimation error floors, one or more (e.g., each) of the candidate DMRS configuration with associated DMRS symbol locations (e.g., relative to a beginning and/or end of a PDSCH allocation) may be addressed separately and/or with a corresponding PDSCH duration assumption in context of DMRS adaptation. In some aspects, this may allow the UE to provide a CSF report that is consistent with the recommended DMRS configuration that may be used directly, or with adjustments, to configure PDSCH transmission parameters.

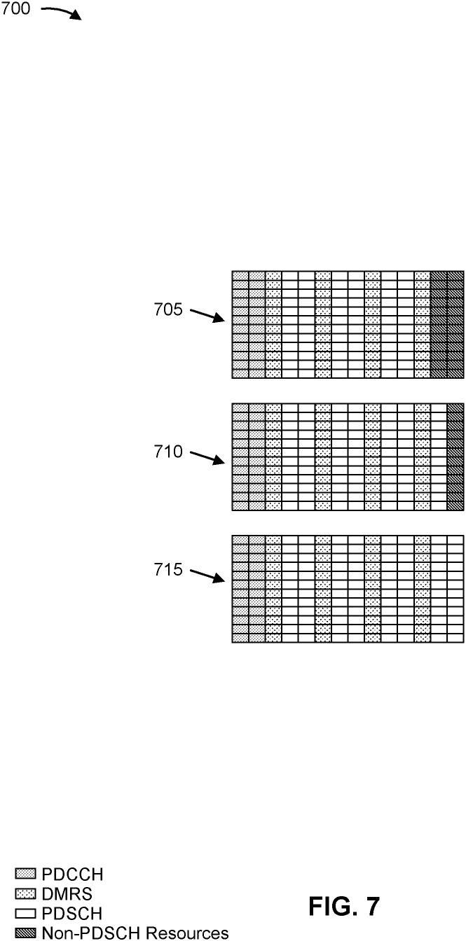

As shown in FIG. 7, and by reference number 705, a DMRS configuration may include two first symbols allocated to a PDCCH, four symbols allocated for DMRSs spaced within six symbols allocated for the data of the PDSCH, and two final symbols allocated for non-PDSCH resources (e.g., a PUSCH).

As shown by reference number 710, a DMRS configuration may include two first symbols allocated to a PDCCH, four symbols allocated for DMRSs spaced within seven symbols allocated for the data of the PDSCH, and one final symbol allocated for non-PDSCH resources.

As shown by reference number 715, a DMRS configuration may include two first symbols allocated to a PDCCH, and four symbols allocated for DMRSs spaced within eight symbols allocated for the data of the PDSCH.

As indicated above, FIGS. 5-7 are provided as examples. Other examples may differ from what is described with respect to FIGS. 5-7.

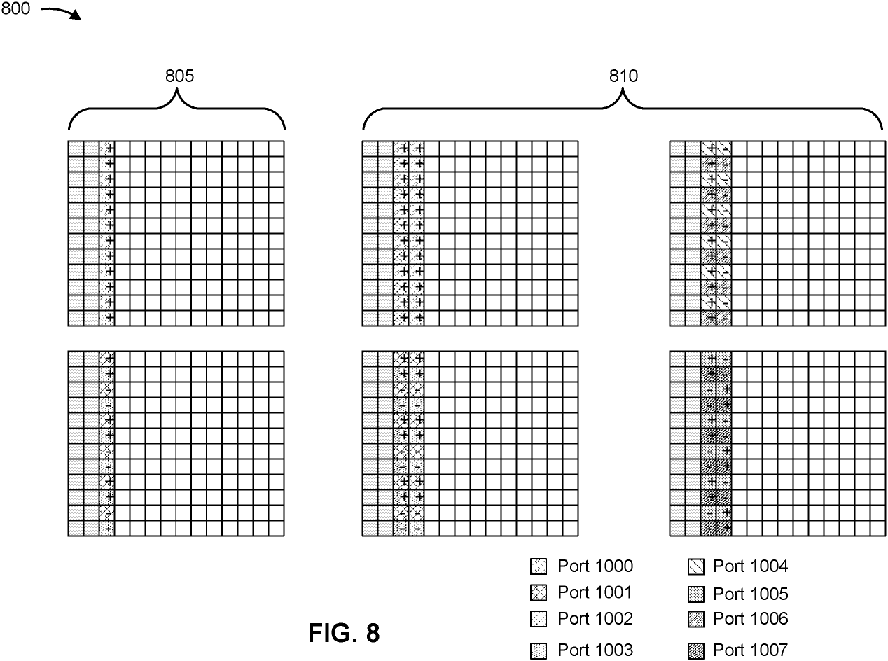

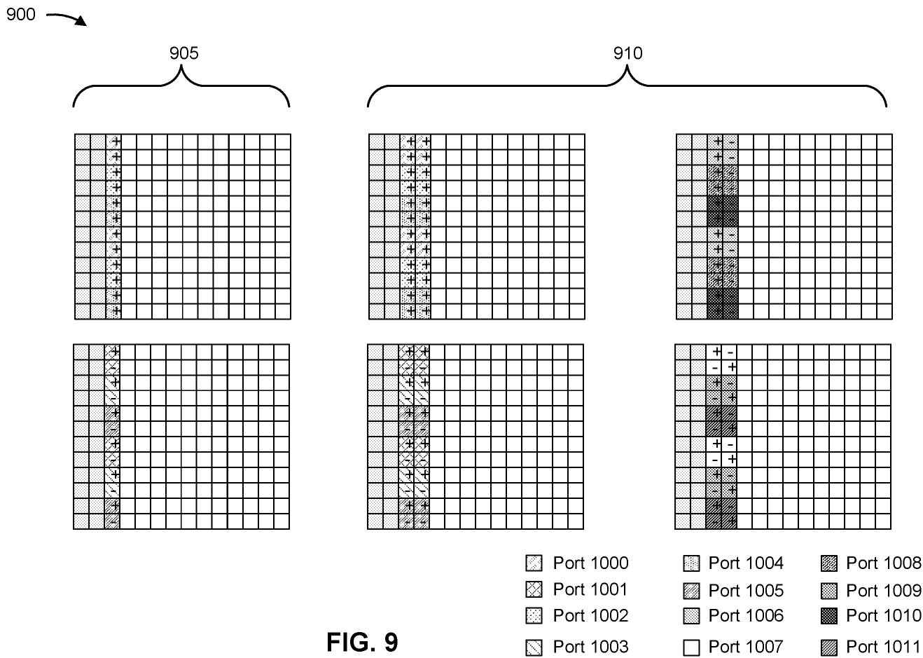

FIGS. 8 and 9 are diagrams illustrating examples associated with types of DMRSs, in accordance with various aspects of the present disclosure.

As shown in FIG. 8, and by reference number 805, a DMRS configuration of DMRS Type A may include one symbol allocated for DMRS locations (e.g., for each DMRS location). A receiving device may receive the DMRSs with two code division multiplexing (CDM) groups, with two DMRS ports per CDM group.

As shown by reference number 810, a DMRS configuration of DMRS Type A may include two symbols allocated for DMRS locations. The receiving device may receive the DMRSs with two CDM groups, with four DMRS ports per CDM group. In this way, the UE may multiplex up to eight DMRS ports per each DMRS location.

As shown in FIG. 9, and by reference number 905, a DMRS configuration of DMRS Type B may include one symbol allocated for DMRSs. A receiving device may receive the DMRSs with three CDM groups, with two DMRS ports per CDM group.

As shown by reference number 910, a DMRS configuration of DMRS Type B may include two symbols allocated per each DMRS location. The receiving device may receive the DMRSs with three CDM groups, with four DMRS ports per CDM group. In this way, the UE may multiplex up to twelve DMRS ports per each DMRS location.

In some aspects, different DMRS types allow different DMRS density on a frequency axis for different channel estimation processing gain (e.g., for highly frequency-selective channels. Different DMRS types may allow different maximum numbers of multiplexed DMRS ports and correspondingly allow different maximum numbers of co-scheduling UEs for MU-MIMO scenarios. In this way, the UE may select a DMRS configuration types that corresponds to an amount of desired channel estimation processing gain. In some aspects, the base station may deviate from the recommended DMRS configuration based at least in part on MU-MIMO co-scheduling related considerations for communications within the wireless network.

As indicated above, FIGS. 8 and 9 are provided as examples. Other examples may differ from what is described with respect to FIGS. 8 and 9. In some aspects, each port may have a difference orthogonal cover code pattern (e.g., indicated by “+” or “-” in the resources to be received by respective ports.

FIG. 10 is a diagram illustrating an example process 1000 performed, for example, by a UE, in accordance with various aspects of the present disclosure. Example process 1000 is an example where the UE (e.g., UE 120 and/or the like) performs operations associated with reporting CSF and correlated DMRS configurations.

As shown in FIG. 10, in some aspects, process 1000 may include selecting, from a set of DMRS configurations, a recommended DMRS configuration for a PDSCH, the recommended DMRS configuration associated with a set of DMRS parameters (block 1010). For example, the UE (e.g., using receive processor 258, controller/processor 280, memory 282, and/or the like) may select, from a set of DMRS configurations, a recommended DMRS configuration for a PDSCH, the recommended DMRS configuration associated with a set of DMRS parameters, as described above.

As further shown in FIG. 10, in some aspects, process 1000 may include transmitting an indication of the recommended DMRS configuration (block 1020). For example, the UE (e.g., using transmit processor 264, controller/processor 280, memory 282, and/or the like) may transmit an indication of the recommended DMRS configuration, as described above.

Process 1000 may include additional aspects, such as any single aspect or any combination of aspects described below and/or in connection with one or more other processes described elsewhere herein.

In a first aspect, transmitting the indication of the recommended DMRS configuration includes transmitting the indication of the recommended DMRS configuration as a part of a CSF report or transmitting the indication of the recommended DMRS configuration coupled to the CSF report.

In a second aspect, alone or in combination with the first aspect, process 1000 includes generating a CSF report based at least in part on the set of DMRS parameters corresponding to the recommended DMRS configuration, and transmitting the CSF report.

In a third aspect, alone or in combination with one or more of the first and second aspects, the CSF report indicates one or more of a CQI, a recommended RI, or a PMI determined based at least in part on the recommended DMRS configuration.

In a fourth aspect, alone or in combination with one or more of the first through third aspects, selecting the recommended DMRS configuration includes selecting the recommended DMRS configuration based at least in part on one or more of channel characteristics or reception conditions estimated based at least in part on one or more downlink reference signals.

In a fifth aspect, alone or in combination with one or more of the first through fourth aspects, the one or more downlink reference signals include one or more of a CSI reference signal, a CSI interference measurement, a TRS, or a DMRS.

In a sixth aspect, alone or in combination with one or more of the first through fifth aspects, a set of definitions for a CSI reference resource, for generating a CSF report, is based at least in part on the set of DMRS parameters.

In a seventh aspect, alone or in combination with one or more of the first through sixth aspects, the set of definitions for the CSI reference resource includes one or more of: a number of one or more front loaded DMRS symbols is based at least in part on the recommended DMRS configuration; a number of one or more additional DMRS symbols is based at least in part on the recommended DMRS configuration; locations of DMRS symbols, relative to a first symbol of a PDSCH allocation, are based at least in part on the recommended DMRS configuration; or a type of DMRS for the PDSCH is based at least in part on the recommended DMRS configuration.

In an eighth aspect, alone or in combination with one or more of the first through seventh aspects, the set of definitions for the CSI reference resource includes one or more of: an allocation duration for a PDSCH is based at least in part on the recommended DMRS configuration, a PDSCH includes DMRS symbols according to the recommended DMRS configuration, or a DMRS boosting configuration and an assumption regarding multiplexing of DMRS resources and data resources on DMRS symbols are based at least in part on the recommended DMRS configuration.

In a ninth aspect, alone or in combination with one or more of the first through eighth aspects, the set of definitions for the CSI reference resource includes a first subset of definitions associated with determinations of one or more of: a transport block size, a code block segmentation, or a code block length associated with determining a channel quality indication; and a second subset of definitions, that is independent from the first subset of definitions, associated with determinations of one or more of: a recommended RI, a PMI, the recommended DMRS configuration, or a CQI.

In a tenth aspect, alone or in combination with one or more of the first through ninth aspects, the first subset of definitions is based at least in part on a set of assumptions including one or more of: a sum of a number of PDSCH symbols and DMRS symbols is equal to 12 symbols, or PDSCH symbols do not include DMRSs.

In an eleventh aspect, alone or in combination with one or more of the first through tenth aspects, process 1000 includes transmitting a CQI report including at least one of a first CQI determined based at least in part on the recommended DMRS configuration, and a second CQI determined based at least in part on a default DMRS configuration.

In a twelfth aspect, alone or in combination with one or more of the first through eleventh aspects, the default DMRS configuration is associated with a set of definitions for a CSI reference resource including one or more of: a number of one or more front loaded DMRS symbols is based at least in part on the default DMRS configuration; a number of one or more additional DMRS symbols is based at least in part on the default DMRS configuration; locations of DMRS symbols, relative to a first symbol of a PDSCH allocation, are based at least in part on the default DMRS configuration; or a type of DMRS for the PDSCH is based at least in part on the default DMRS configuration.

In a thirteenth aspect, alone or in combination with one or more of the first through twelfth aspects, the default DMRS configuration is associated with a set of definitions for a CSI reference resource including one or more of: an allocation duration for a PDSCH is based at least in part on the default DMRS configuration, a PDSCH includes DMRS symbols according to the default DMRS configuration, or a DMRS boosting configuration and an assumption regarding multiplexing of DMRS resources and data resources on DMRS symbols are based at least in part on the default DMRS configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with various aspects of the present disclosure. Example process 1100 is an example where the base station (e.g., base station 110 and/or the like) performs operations associated with reporting CSF and correlated DMRS configurations.

As shown in FIG. 11, in some aspects, process 1100 may include receiving a CSF report and an indication of a recommended DMRS configuration associated with one or more parameters used by a UE to generate the CSF report (block 1110). For example, the base station (e.g., using receive processor 238, controller/processor 240, memory 242, and/or the like) may receive a CSF report and an indication of a recommended DMRS configuration associated with one or more parameters used by a UE to generate the CSF report, as described above.

As further shown in FIG. 11, in some aspects, process 1100 may include selecting, based at least in part on the CSF report and the recommended DMRS configuration, transmission parameters, including a DMRS configuration, to use for a PDSCH (block 1120). For example, the base station (e.g., using transmit processor 220, receive processor 238, controller/processor 240, memory 242, and/or the like) may select, based at least in part on the CSF report and the recommended DMRS configuration, transmission parameters, including a DMRS configuration, to use for a PDSCH, as described above.

Process 1100 may include additional aspects, such as any single aspect or any combination of aspects described below and/or in connection with one or more other processes described elsewhere herein.

In a first aspect, process 1100 includes determining, based at least in part on one or more scheduling restraints, whether to use the recommended DMRS configuration.

In a second aspect, alone or in combination with the first aspect, process 1100 includes adjusting one or more transmission parameters associated with the CSF report or the recommended DMRS configuration based at least in part on a set of CSI reference resource definitions.

In a third aspect, alone or in combination with one or more of the first and second aspects, receiving the indication of the recommended DMRS configuration includes receiving the indication of the recommended DMRS configuration as a part of the CSF report, or receiving the indication of the recommended DMRS configuration coupled to the CSF report.

In a fourth aspect, alone or in combination with one or more of the first through third aspects, the CSF report indicates a CQI determined based at least in part on the recommended DMRS configuration.

In a fifth aspect, alone or in combination with one or more of the first through fourth aspects, a set of definitions for a CSI reference resource, used by the UE to generate the CSF report, is based at least in part on one or more DMRS parameters.

In a sixth aspect, alone or in combination with one or more of the first through fifth aspects, the set of definitions for the CSI reference resource includes one or more of: a number of one or more front loaded DMRS symbols is based at least in part on the recommended DMRS configuration; a number of one or more additional DMRS symbols is based at least in part on the recommended DMRS configuration; locations of DMRS symbols, relative to a first symbol of a PDSCH allocation, are based at least in part on the recommended DMRS configuration; or a type of DMRS for the PDSCH is based at least in part on the recommended DMRS configuration.

In a seventh aspect, alone or in combination with one or more of the first through sixth aspects, the set of definitions for the CSI reference resource includes one or more of: an allocation duration for a PDSCH is based at least in part on the recommended DMRS configuration, a PDSCH includes DMRS symbols according to the recommended DMRS configuration, or a DMRS boosting configuration and an assumption regarding multiplexing of DMRS resources and data resources on DMRS symbols are based at least in part on the recommended DMRS configuration.

In an eighth aspect, alone or in combination with one or more of the first through seventh aspects, the set of definitions for the CSI reference resource includes a first subset of definitions associated with determinations of one or more of: a transport block size, a code block segmentation, or a code block length associated with determining a channel quality indication; and a second subset of definitions, that is independent from the first subset of definitions, associated with determinations of one or more of: a recommended RI, a PMI, the recommended DMRS configuration, or a CQI.

In a ninth aspect, alone or in combination with one or more of the first through eighth aspects, the first subset of definitions is based at least in part on a set of assumptions including one or more of: a sum of a number of PDSCH symbols and DMRS symbols is equal to 12 symbols, or PDSCH symbols do not include DMRSs.

In a tenth aspect, alone or in combination with one or more of the first through ninth aspects, process 1100 includes receiving a CQI report including at least one of a first CQI determined based at least in part on the recommended DMRS configuration, and a second CQI determined based at least in part on a default DMRS configuration.

In an eleventh aspect, alone or in combination with one or more of the first through tenth aspects, the default DMRS configuration is associated with a set of definitions for a CSI reference resource including one or more of: a number of one or more front loaded DMRS symbols is based at least in part on the default DMRS configuration, a number of one or more additional DMRS symbols is based at least in part on the default DMRS configuration, locations of DMRS symbols, relative to a first symbol of a PDSCH allocation, are based at least in part on the default DMRS configuration, or a type of DMRS for the PDSCH is based at least in part on the default DMRS configuration.

In a twelfth aspect, alone or in combination with one or more of the first through eleventh aspects, the default DMRS configuration is associated with a set of definitions for a CSI reference resource including one or more of: an allocation duration for a PDSCH is based at least in part on the default DMRS configuration, a PDSCH includes DMRS symbols according to the default DMRS configuration, or a DMRS boosting configuration and an assumption regarding multiplexing of DMRS resources and data resources on DMRS symbols are based at least in part on the default recommended DMRS configuration.

In a thirteenth aspect, alone or in combination with one or more of the first through twelfth aspects, process 1100 includes transmitting, to the UE, an indication of the DMRS configuration; and transmitting, to the UE, the PDSCH based at least in part on the DMRS configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors operatively coupled to the memory, the one or more processors configured to:
select, from a set of demodulation reference signal (DMRS) configurations, a recommended DMRS configuration for a physical downlink shared channel (PDSCH), the recommended DMRS configuration associated with a set of DMRS parameters; and
transmit an indication of the recommended DMRS configuration.

2. The UE of claim 1, wherein the one or more processors, to transmit the indication of the recommended DMRS configuration, are configured to:
transmit the indication of the recommended DMRS configuration as a part of a channel state feedback (CSF) report, or
transmit the indication of the recommended DMRS configuration coupled to the CSF report.

3. The UE of claim 1, wherein the one or more processors are configured to:
generate a CSF report based at least in part on the set of DMRS parameters corresponding to the recommended DMRS configuration; and
transmit the CSF report.

4. The UE of claim 3, wherein the CSF report indicates one or more of a channel quality indicator, a recommended rank indicator, or a pre-coding matrix indicator determined based at least in part on the recommended DMRS configuration.

5. The UE of claim 1, wherein the one or more processors, to select the recommended DMRS configuration, are configured to:
select the recommended DMRS configuration based at least in part on one or more of channel characteristics or reception conditions estimated based at least in part on one or more downlink reference signals.

6. The UE of claim 5, wherein the one or more downlink reference signals include one or more of a channel state information (CSI) reference signal, a CSI interference measurement, a tracking reference signal, or a DMRS.

7. The UE of claim 1, wherein a set of definitions for a channel state information reference resource, for generating a channel state feedback report, is based at least in part on the set of DMRS parameters.

8. The UE of claim 7, wherein the set of definitions for the channel state information reference resource includes one or more of:
a number of one or more front loaded DMRS symbols is based at least in part on the recommended DMRS configuration,
a number of one or more additional DMRS symbols is based at least in part on the recommended DMRS configuration,
locations of DMRS symbols, relative to one or more of a first or last symbol of a physical downlink shared channel allocation, are based at least in part on the recommended DMRS configuration, or
a type of DMRS for the PDSCH is based at least in part on the recommended DMRS configuration.

9. The UE of claim 7, wherein the set of definitions for the channel state information reference resource includes one or more of:
an allocation duration for a physical downlink shared channel is based at least in part on the recommended DMRS configuration,
a physical downlink shared channel includes DMRS symbols according to the recommended DMRS configuration, or
a DMRS boosting configuration and an assumption regarding multiplexing of DMRS resources and data resources on DMRS symbols are based at least in part on the recommended DMRS configuration.

10. The UE of claim 7, wherein the set of definitions for the channel state information reference resource comprises:
a first subset of definitions associated with determinations of one or more of a transport block size, a code block segmentation, or a code block length associated with determining a channel quality indication, and
a second subset of definitions, that is independent from the first subset of definitions, associated with determinations of one or more of a recommended rank indicator, a pre-coding matrix indicator, the recommended DMRS configuration, or a channel quality indicator.

11. The UE of claim 10, wherein the first subset of definitions is based at least in part on a set of assumptions including one or more of:
a sum of a number of physical downlink shared channel (PDSCH) symbols and DMRS symbols is equal to 12 symbols, or
PDSCH symbols do not include DMRSs.

12. The UE of claim 1, wherein the one or more processors are configured to:
transmit a channel quality indicator (CQI) report including at least one of:
a first CQI determined based at least in part on the recommended DMRS configuration, and
a second CQI determined based at least in part on a default DMRS configuration.

13. The UE of claim 12, wherein the default DMRS configuration is associated with a set of definitions for a channel state information reference resource including one or more of:
a number of one or more front loaded DMRS symbols is based at least in part on the default DMRS configuration,
a number of one or more additional DMRS symbols is based at least in part on the default DMRS configuration,
locations of DMRS symbols, relative to a one or more of a first or last symbol of a physical downlink shared channel allocation, are based at least in part on the default DMRS configuration, or
a type of DMRS for the PDSCH is based at least in part on the default DMRS configuration.

14. The UE of claim 12, wherein the default DMRS configuration is associated with a set of definitions for a channel state information reference resource including one or more of:
an allocation duration for a physical downlink shared channel is based at least in part on the default DMRS configuration,
a physical downlink shared channel includes DMRS symbols according to the default DMRS configuration, or
a DMRS boosting configuration and an assumption regarding multiplexing of DMRS resources and data resources on DMRS symbols are based at least in part on the recommended DMRS configuration.

15. A network node for wireless communication, comprising:
a memory; and
one or more processors operatively coupled to the memory, the one or more processors configured to:
receive a channel state feedback (CSF) report and an indication of a recommended DMRS configuration associated with one or more parameters used by a user equipment (UE) to generate the CSF report; and
select, based at least in part on the CSF report and the recommended DMRS configuration, transmission parameters, including a DMRS configuration, to use for a physical downlink shared channel (PDSCH).

16. The network node of claim 15, wherein the one or more processors are configured to:
select, based at least in part on one or more scheduling restraints, whether to use the recommended DMRS configuration.

17. The network node of claim 15, wherein the one or more processors are configured to:
adjust one or more transmission parameters associated with the CSF report or the recommended DMRS configuration based at least in part on a set of CSI reference resource definitions.

18. The network node of claim 15, wherein the one or more processors, to receive the indication of the recommended DMRS configuration, are configured to:
receive the indication of the recommended DMRS configuration as a part of the CSF report, or
receive the indication of the recommended DMRS configuration coupled to the CSF report.

19. The network node of claim 15, wherein the CSF report indicates a channel quality indicator determined based at least in part on the recommended DMRS configuration.

20. The network node of claim 15, wherein a set of definitions for a channel state information reference resource, used by the UE to generate the CSF report, is based at least in part on one or more DMRS parameters.

21. The network node of claim 20, wherein the set of definitions for the channel state information reference resource includes one or more of:
a number of one or more front loaded DMRS symbols is based at least in part on the recommended DMRS configuration,
a number of one or more additional DMRS symbols is based at least in part on the recommended DMRS configuration,
locations of DMRS symbols, relative to one or more of a first or last symbol of a physical downlink shared channel allocation, are based at least in part on the recommended DMRS configuration, or
a type of DMRS for the PDSCH is based at least in part on the recommended DMRS configuration.

22. The network node of claim 20, wherein the set of definitions for the channel state information reference resource includes one or more of:
an allocation duration for a physical downlink shared channel is based at least in part on the recommended DMRS configuration,
a physical downlink shared channel includes DMRS symbols according to the recommended DMRS configuration, or
a DMRS boosting configuration and an assumption regarding multiplexing of DMRS resources and data resources on DMRS symbols are based at least in part on the recommended DMRS configuration.

23. The network node of claim 20, wherein the set of definitions for the channel state information reference resource comprises:
a first subset of definitions associated with determinations of one or more of a transport block size, a code block segmentation, or a code block length associated with determining a channel quality indication, and
a second subset of definitions, that is independent from the first subset of definitions, associated with determinations of one or more of a recommended rank indicator, a pre-coding matrix indicator, the recommended DMRS configuration, or a channel quality indicator.

24. The network node of claim 23, wherein the first subset of definitions is based at least in part on a set of assumptions including one or more of:
a sum of a number of physical downlink shared channel (PDSCH) symbols and DMRS symbols is equal to 12 symbols, or
PDSCH symbols do not include DMRSs.

25. The network node of claim 15, wherein the one or more processors are configured to:
receive a channel quality indicator report including at least one of:
a first CQI determined based at least in part on the recommended DMRS configuration, and
a second CQI determined based at least in part on a default DMRS configuration.

26. The network node of claim 25, wherein the default DMRS configuration is associated with a set of definitions for a channel state information reference resource including one or more of:
a number of one or more front loaded DMRS symbols is based at least in part on the default DMRS configuration,
a number of one or more additional DMRS symbols is based at least in part on the default DMRS configuration,
locations of DMRS symbols, relative to one or more of a first or last symbol of a physical downlink shared channel allocation, are based at least in part on the default DMRS configuration, or
a type of DMRS for the PDSCH is based at least in part on the default DMRS configuration.

27. The network node of claim 25, wherein the default DMRS configuration is associated with a set of definitions for a channel state information reference resource including one or more of:
an allocation duration for a physical downlink shared channel is based at least in part on the default DMRS configuration,
a physical downlink shared channel includes DMRS symbols according to the default DMRS configuration, or
a DMRS boosting configuration and an assumption regarding multiplexing of DMRS resources and data resources on DMRS symbols are based at least in part on the default DMRS configuration.

28. The network node of claim 15, wherein the one or more processors are configured to:
transmit, to the UE, an indication of the DMRS configuration; and transmitting, to the UE, the PDSCH based at least in part on the DMRS configuration.

29-32. (canceled)

33. A method of wireless communication performed by a user equipment (UE), comprising:
selecting, from a set of demodulation reference signal (DMRS) configurations, a recommended DMRS configuration for a physical downlink shared channel (PDSCU), the recommended DMRS configuration associated with a set of DMRS parameters; and
transmitting an indication of the recommended DMRS configuration.

34. A method of wireless communication performed by a network node, comprising:
receiving a channel state feedback (CSF) report and an indication of a recommended DMRS configuration associated with one or more parameters used by a user equipment (UE) to generate the CSF report; and
selecting, based at least in part on the CSF report and the recommended DMRS configuration, transmission parameters, including a DMRS configuration, to use for a physical downlink shared channel (PDSCU).

35. The method of claim 34, further comprising:
receiving a channel quality indicator report including at least one of:
a first CQI determined based at least in part on the recommended DMRS configuration, and
a second CQI determined based at least in part on a default DMRS configuration.

36. The method of claim 33, wherein selecting the recommended DMRS configuration comprises:
selecting the recommended DMRS configuration based at least in part on one or more of channel characteristics or reception conditions estimated based at least in part on one or more downlink reference signals.
